(19) United States
(12) Patent Application Publication
(10) Pub. No.: US 2026/0349437 A1
(43) Pub. Date: Nov. 5, 2026

(54) PATH PLANNING DEVICE, METHOD, PROGRAM, AND MULTI-AGENT CONTROL SYSTEM

(71) Applicant: OMRON CORPORATION, Kyoto (JP)

(72) Inventor: Kazumi KASAURA, Tokyo (JP)

(73) Assignee: OMRON CORPORATION, Kyoto (JP)

(21) Appl. No.: 19/146,715

(22) PCT Filed: Jan. 9, 2024
(86) PCT No.: PCT/JP2024/000160

§ 371 Date: Jun. 23, 2026

(30) Foreign Application Priority Data
Jan. 24, 2023 (JP) 2023-009009

(51) Int. Cl. G05D 1/644; G05D 1/622; G05D 1/693; G05D 107/70; G05D 109/10

(52) U.S. Cl. CPC G05D 1/644; G05D 1/622; G05D 1/693; G05D 2107/70; G05D 2109/10

(57) ABSTRACT

Plural pairs of appearance points and destination points are defined in an area. The appearance points are entry points of plural agents (50) into the area, and the destination points are exit points of the agents (50) from the area. When the plural agents (50) respectively appear with a periodic appearance cycle at respective appearance points, a calculation unit (22) calculates an initial solution of respective paths of the plural agents (50) from the appearance points to the destination points. A planning unit (24) optimizes the initial solution and plans the respective paths of the plurality of agents (50). The planning unit optimizes (24) the initial solution so as to satisfy constraints, including collision avoidance between the agents (50), and minimize the appearance cycle.

### TECHNICAL FIELD

The present disclosure relates to a path planning device, a path planning method, a path planning program, and a multi-agent control system.

### BACKGROUND ART

The problem of planning paths for plural agents with certain sizes in a single area, from respective start points to respective destinations, without the agents colliding with one another is referred to as multi-agent path planning (MAPP). One augmentation of MAPP is known as Online MAPP, in which new movement tasks for agents are assigned during the execution of a path plan.

Methods that can be employed for Online MAPP include, for example, a method of specifying an order of priority for the agents by some process, planning for the agents in order from the agents with highest priority, and reserving areas in space and times accordingly (for example, see Non-Patent Reference 1). In this method, planning for agents with lower priority is carried out so as to avoid areas reserved by agents with higher priority. A common way of determining the order of priority is first-come-first-served, which prioritizes agents that arrive earlier.

Methods that can be employed for Online MAPP also include, for example, a method of planning the paths of all agents in an area each time a new agent arrives (for example, see Non-Patent Reference 2).

### Related Art References

### Non-Patent References

Non-Patent Reference 1: Kurt Dresner, Peter Stone, “A Multiagent Approach to Autonomous Intersection Management,” Journal of Artificial Intelligence Research 31 (2008), p. 591-656, 2008 Mar. 31.
Non-Patent Reference 2: Jiří Švancara, Marek Vlk, Roni Stern, Dor Atzmon, Roman Barták, “Online Multi-Agent Pathfinding,” Proceedings of the AAAI Conference on Artificial Intelligence, p. 7732-7739, 2019 Jul. 17.

### SUMMARY OF INVENTION

### Technical Problem

Tasks in Online MAPP may be to specify plural pairs of an appearance point and a destination point in an area in advance and, for each agent successively appearing in the area, to plan a path in real time that corresponds to one of these pairs. For example, for respective agents coming and going through an intersection, paths from appearance points to destination points that do not collide with one another may be planned and the like. This task may increase throughput, expressed as a number of agents passing through the area in a certain duration.

In the method described in Non-Patent Reference 1 above, when planning for an agent with a higher priority, no consideration is given to space for the paths of agents with lower priority. Consequently, harmonious movements may not be possible and a high throughput may not be achieved. Moreover, when deciding a path for a subsequent agent, reservation states of the paths of agents that are already in the area must be acquired. Therefore, processing that includes communicating with a control device such as an intersection manager or the like is necessary.

In the method described in Non-Patent Reference 2, the higher the concentration of agents, the more calculation time is required for planning. As a result, planning paths in real-time becomes impractical. Moreover, each time a new agent enters the area, all agents in the area must perform communications. As a result, communication costs are even higher than in the method described in Non-Patent Reference 1.

The present disclosure is made in consideration of the issues described above, and an object of the present disclosure is to perform path planning with high throughput in multi-agent path planning that assigns new movement tasks for agents during execution of a path plan.

### Solution to Problem

In order to achieve the object described above, a path planning device according to the present disclosure includes: a calculation unit that, when plural agents respectively appear with a periodic appearance cycle at respective appearance points in an area in which plural pairs of the appearance points and destination points are defined, calculates an initial solution of respective paths of the plural agents from the appearance points to the destination points, the appearance points being entry points of the agents into the area, and the destination points being exit points of the agents from the area; and a planning unit that optimizes the initial solution and plans the respective paths of the plural agents, the planning unit optimizing so as to satisfy constraints and minimize the appearance cycle, and the constraints including collision avoidance between the agents.

A path planning method according to the present disclosure includes: when plural agents respectively appear with a periodic appearance cycle at respective appearance points in an area in which plural pairs of the appearance points and destination points are defined, calculating an initial solution of respective paths of the plural agents from the appearance points to the destination points, the appearance points being entry points of the agents into the area, and the destination points being exit points of the agents from the area; and optimizing the initial solution and planning the respective paths of the plural agents, including optimizing so as to satisfy constraints and minimize the appearance cycle, the constraints including collision avoidance between the agents.

A path planning program according to the present disclosure causes a computer to function as: a calculation unit that, when plural agents respectively appear with a periodic appearance cycle at respective appearance points in an area in which plural pairs of the appearance points and destination points are defined, calculates an initial solution of respective paths of the plural agents from the appearance points to the destination points, the appearance points being entry points of the agents into the area, and the destination points being exit points of the agents from the area; and a planning unit that optimizes the initial solution and plans the respective paths of the plural agents, the planning unit optimizing so as to satisfy constraints and minimize the appearance cycle, and the constraints including collision avoidance between the agents.

A multi-agent control system according to the present disclosure includes a control device and plural agents. The control device includes: a calculation unit that, when the plural agents respectively appear with a periodic appearance cycle at respective appearance points in an area in which plural pairs of the appearance points and destination points are defined, calculates an initial solution of respective paths of the plural agents from the appearance points to the destination points, the appearance points being entry points of the agents into the area, and the destination points being exit points of the agents from the area; a planning unit that optimizes the initial solution and plans the respective paths of the plural agents, the planning unit optimizing so as to satisfy constraints and minimize the appearance cycle, and the constraints including collision avoidance between the agents; and a communication unit that notifies each of the plural agents with the optimized appearance cycle and the path. Each of the plural agents: enters the area at the timing of the notified appearance cycle; when the each agent appears prior to the timing of the appearance cycle, waits in a pathway that is specified outside the area until the timing of the appearance cycle, the pathway passing through the appearance point; after entering the area, moves from the appearance point to the destination point along the notified path; and when reaching the destination point, exits from the area.

### Advantageous Effects of Invention

According to the path planning device, method, program and multi-agent control system according to the present disclosure, in multi-agent path planning that assigns new movement tasks for agents during execution of a path plan, path planning with high throughput may be achieved.

### BRIEF DESCRIPTION OF DRAWINGS

FIG. 1 is a block diagram showing schematic structures of a multi-agent control system.

FIG. 2 is a block diagram showing hardware structures of a control device.

FIG. 3 is a diagram for describing pairs of appearance points and destination points in an area

FIG. 4 is views showing examples of paths.

FIG. 5 is a diagram for describing pathways in which agents wait.

FIG. 6 is a flowchart showing a flow of path planning processing.

FIG. 7 is a diagram showing an example of an area corresponding to an intersection for self-driving vehicles.

### DETAILED DESCRIPTION

Below, an example of an embodiment of the present disclosure is described with reference to the drawings. In the drawings, the same reference symbols are assigned to structural elements and portions that are the same or equivalent. Dimensions and proportions in the drawings may be exaggerated to aid understanding and may be different from actual proportions.

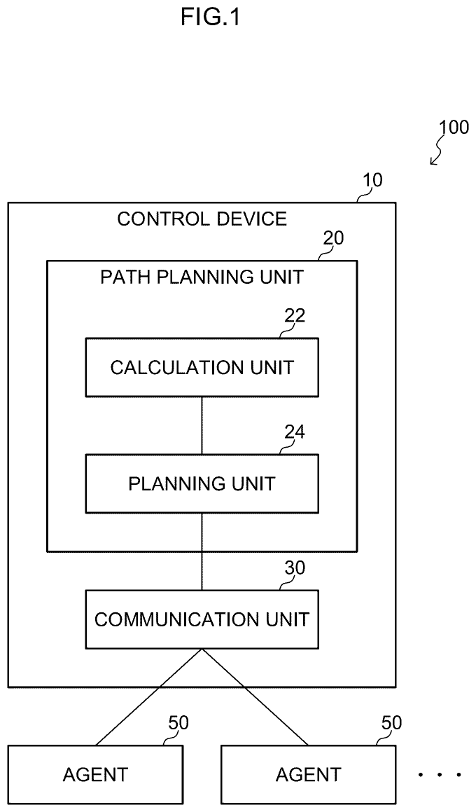

As shown in FIG. 1, a multi-agent control system 100 according to the present exemplary embodiment includes a control device 10 and plural agents 50.

Each agent 50 is, for example, a self-driving vehicle under automatic intersection management, an autonomous mobile robot (AMR), automatic guided vehicle (AGV) or the like in a warehouse, a factory or such, a drone of an unmanned delivery system, or the like. The agent 50 includes movement equipment for running, flying or the like, communication equipment for communicating with the control device 10, and movement control equipment for controlling the movement equipment so as to move along a planned path.

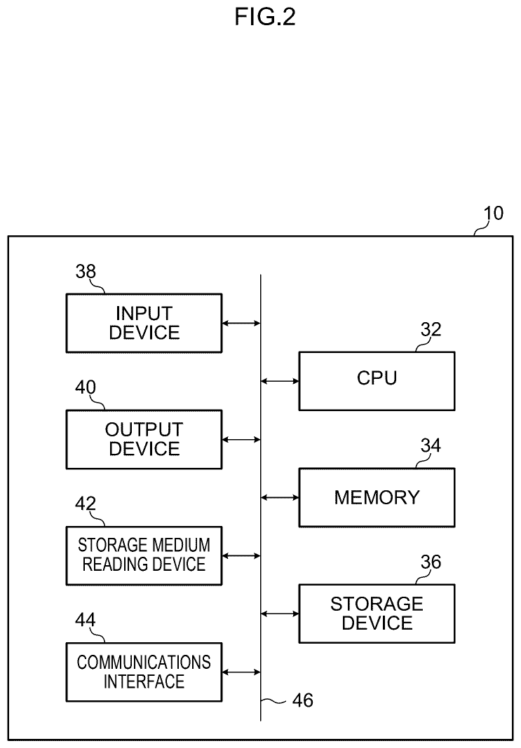

FIG. 2 is a block diagram showing hardware structures of the control device 10. As shown in FIG. 2, the control device 10 includes a central processing unit (CPU) 32, memory 34, a memory device 36, an entry device 38, an output device 40, a memory medium reading device 42 and a communications interface (I/F) 44. These structures are connected to be capable of communicating with one another via a bus 46.

The memory device 36 stores a path planning program for executing path planning processing. The CPU 32 is a central arithmetic processing unit, which executes various programs and controls various structures. That is, the CPU 32 reads the program from the memory device 36 and executes the program using the memory 34 as a work area. The CPU 32 conducts control of the above-mentioned structures and various computations in accordance with the program memorized at the memory device 36.

The memory 34 is structured by random access memory (RAM) and serves as a work area, temporarily memorizing the program and data. The memory device 36 is structured by read-only memory (ROM), a hard disk drive (HDD), a solid state drive (SSD) or the like. The memory device 36 stores various programs, including an operating system, and various kinds of data.

The entry device 38 is equipment for conducting various kinds of entry such as, for example, a keyboard and mouse or the like. The output device 40 is equipment for outputting various kinds of information such as, for example, a display, a printer or the like. When a touch panel display is employed as the output device 40, the touch panel display may also function as the entry device 38.

The memory medium reading device 42 reads data memorized at various types of memory medium, such as a compact disc (CD-ROM), digital versatile disc (DVD-ROM), Blu-ray disc, universal serial bus (USB) memory or the like, writes data to the memory medium, and so forth. The communication interface 44 is an interface for communicating with other equipment using a standard such as, for example, Ethernet (registered trademark), FDDI, Wi-Fi (registered trademark) or the like.

As shown in FIG. 1, functionally, the control device 10 includes a path planning unit 20 and a communication unit 30. The path planning unit 20 includes a calculation unit 22 and a planning unit 24. The path planning unit 20 is an example of the path planning device of the present disclosure. The functional structures are realized by the CPU 32 reading the path planning program memorized at the memory device 36, loading the program into the memory 34 and executing the program.

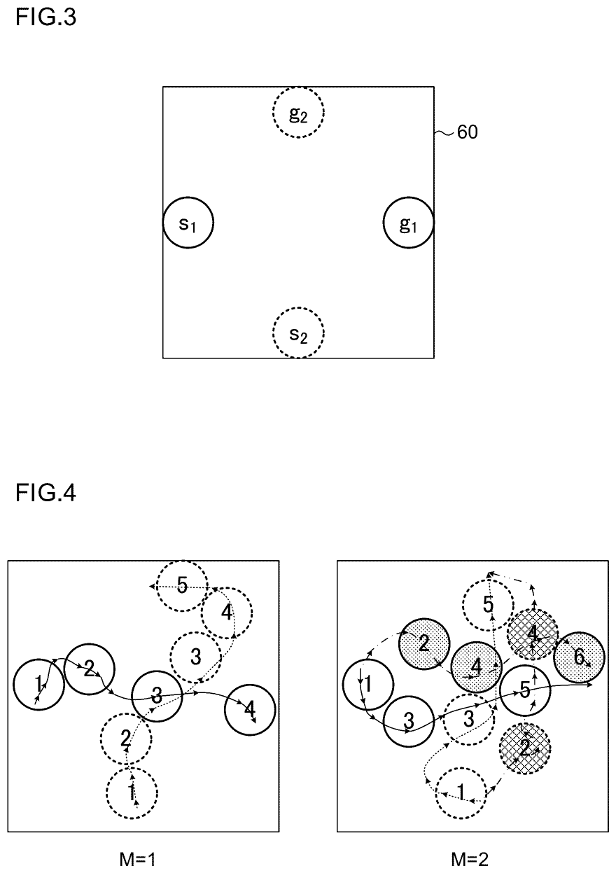

As illustrated in FIG. 3, in the present exemplary embodiment plural pairs of appearance points and destination points are defined in an area 60. The appearance points are entry points of the agents 50, and the destination points are exit points of the agents 50. The path planning unit 20 plans a path from an appearance point to a destination point for each of the plural agents 50 successively entering into the area 60. The example in FIG. 3 illustrates a situation in which two pairs are defined in the area 60, a pair of an appearance point s₁ and a destination point g₁, which are depicted as continuous line circles, and a pair of an appearance point s₂ and a destination point g₂, which are depicted as broken line circles.

The path planning unit 20 plans paths for the plural agents 50 by solving a problem (below referred to as “periodic MAPP”) in which it is assumed that appearances of the agents 50 at the appearance points in the area 60 are periodic. Formularization of the periodic MAPP problem in the present exemplary embodiment is described below.

More specifically, the path planning unit 20 sets an integer M, referred to as “cycles”, and for each of lanes represented by the pairs of appearance points and destination points, defines M paths: a path of cycle 0, a path of cycle 1, . . . , a path of cycle M−1. Then, if the agents 50 successively appearing at the respective lanes with a predetermined period are to follow the paths corresponding to the cycle numbers among the M paths in rotation, the path planning unit 20 finds a solution of the paths with the smallest possible period, such that no collisions occur. After the agent 50 that follows the path of cycle M−1, the agent 50 that appears next follows the path of cycle 0.

FIG. 4 shows examples of paths for the example of pairs of appearance points and destination points shown in FIG. 3. The left side drawing in FIG. 4 shows a case when M=1, showing positions that the agents 50 pass through at respective times after appearing. The solid line circles depict a lane from s₁ to g₁ and the broken line circles depict a lane from s₂ to g₂. The solid line arrows depict tracks in individual periods on the lane from s₁ to g₁, and the broken line arrows depict tracks in individual periods on the lane from s₂ to g₂. The right side drawing in FIG. 4 shows a case when M=2. The solid-line white circles depict positions of an agent on the lane from s₁ to g₁ in cycle 0, the solid-line shaded circles depict positions of an agent on the lane from s₁ to g₁ in cycle 1, the broken-line white circles depict positions of an agent on the lane from s₂ to g₂ in cycle 0, and the broken-line latticed circles depict positions of an agent on the lane from s₂ to g₂ in cycle 1. The solid line arrows depict tracks in individual periods on the lane from s₁ to g₁ in cycle 0, the single-dot chain arrows depict tracks in individual periods on the lane from s₁ to g₁ in cycle 1, the broken-line arrows depict tracks in individual periods on the lane from s₂ to g₂ in cycle 0, and the single-dot chain arrows depict tracks in individual periods on the lane from s₂ to g₂ in cycle 1.

For the sake of simplicity, the periodic MAPP problem according to the present exemplary embodiment assumes that all the agents 50 have bodies that can be modeled as circles with the same fixed radius and that speeds of the agents 50 comply with the simple dynamic constraint of not being able to exceed a particular maximum speed. The periodic MAPP problem is instantiated by a tuple (E, {(s₁,g₁), . . . , (s_{N},g_{N})}, r, vₘₐₓ). The environment E⊆R² (R is the set of all real numbers) represents a set of points in the two-dimensional area 60 excluding obstructions and the like. The set {(s₁,g₁), . . . , (s_{N},g_{N})} represents N pairs of appearance points sₙ and destination points gₙ in the area 60, in which sₙ,gₙ ∈E. The variables r and vₘₐₓ represent the radius and maximum speed of each agent 50.

A time period in which a new set of the agents 50 appears at the appearance points s₁, . . . s_{N} is represented by a period τ∈R₊. The period τ is an example of the appearance cycle of the present disclosure. The cycles are represented by M∈N₊. A cycle plan for M cycles is denoted by a set of M×N paths, Γ_{M}=(γ_{n,m}: [0, T_{n,m}]→E)_{1≤n≤N,} 0≤m<M. That is, the symbol γ_{n,m} represents the path of an agent 50 that appears at lane n in the area 60 in cycle m. This is a path along which the agent 50 moves from the appearance point to the destination point in an interval from time t=0 to t=T_{n,m}. The cycle plan must satisfy the constraints below.

### Constraint of Appearance Points and Destination Points

For all of 1≤n≤N and 0≤m<M, γ_{n,m} (0)=sₙ and γ_{n,m} (T_{n,m})=gₙ

### Constraint of Maximum Speed of the Agents 50

For all of 1≤n≤N, 0≤m<M, and t∈[0,T_{n,m}], maximum speeds of the agents 50 satisfy expression (1) below.

$$\vert \frac{d {γ}_{n , m}}{dt} ( t ) \vert \leq {v}_{max} . \qquad ( 1 )$$

Constraint of Clearances from Boundaries

When x represents a position in the area 60 and dist_{ε}(x) represents a distance from a boundary of the environment E to x∈E, expression (2) below is satisfied for all of 1≤n≤N, 0≤m<M, and t∈[0,T_{n,m}].

dist_{ε}(γ_{n,m}(t))≥r. (2)

### Constraint of Collision Avoidance

Expression (3) below is satisfied for all of 1≤n,n′≤N, 0≤m,m′<M, t∈[0,T_{n,m}] and t′∈[0,T_{n′,m′}], where (m−m′)τ+(t−t′)∈MτZ (Z is the set of all integers) and (n,m,t)≠(n′,m′,t′).

|γ_{n,m}(t)−γ_{n′,m′}(t′)|≥2r. (3)

The path planning unit 20 represents each path γ_{n,m} as a finite number of variables approximating a polygonal chain. More specifically, the path planning unit 20 represents each path γ_{n,m} as a sequence of positions of the agent 50 at K+1 times of respective time steps Δt_{n,m}. That is, γ_{n,m}=((x_{n,m,0}, 0), (x_{n,m,1}, Δt_{n,m}), . . . , (x_{n,m,K},KΔt_{n,m})). Here, x_{n,m,k} ∈E, x_{n,m,0}=sₙ, x_{n,m,K}=gₙ and KΔt_{n,m}=T_{n,m}. The agent 50 is assumed to move linearly at a certain speed v_{n,m,k} between two positions x_{n,m,k} and x_{n,m,k+1}. This discretized representation must satisfy the constraint of maximum speed in expression (1). Therefore, expression (1) can be rewritten as the below expression (4).

$${v}_{n , m , k} := \vert \frac{{x}_{n , m , k + 1} - {x}_{n , m , k}}{Δ {t}_{n , m}} \vert \leq {v}_{max} , \qquad ( 4 )$$

In addition, the constraint of clearances from boundaries in expression (2) can be rewritten as the below expression (5).

dist_{√}(x_{n,m,k})≥r. (5)

The constraint of collision avoidance in expression (3) can be rewritten as below. First, expression (6) and expression (7) are defined.

$${r}_{q} ( t ) := t - ⌊ \frac{t}{q} ⌋ q , \qquad ( 6 )$$

$$C := \{ ( n , m , k , {n}^{′} , {m}^{′} , {k}^{′} ) \vert 1 \leq n , {n}^{′} \leq N , 0 \leq m , {m}^{′} < M , 0 \leq k , {k}^{′} < K , 0 \leq {r}_{M τ} ( ( m - {m}^{′} ) τ + k Δ {t}_{n , m} - {k}^{′} Δ {t}_{{n}^{′} , {m}^{′}} ) < Δ {t}_{{n}^{′} , {m}^{′}} , ( n , m , k ) \neq ( {n}^{′} , {m}^{′} , {k}^{′} ) . \} . \qquad ( 7 )$$

Using the term α given in expression (9), the constraint of collision avoidance can be rewritten as expression (8) for all of (n,m,k,n′,m′,k′)∈C.

$${d}_{n , m , k , {n}^{′} , {m}^{′} , {k}^{′}} := \vert {x}_{n , m , k} - ( ( 1 - α ) {x}_{{n}^{′} , {m}^{′} , {k}^{′}} + α {x}_{{n}^{′} , {m}^{′} , {k}^{′} + 1} ) \vert \geq 2 r , \qquad ( 8 )$$

$$α = \frac{{r}_{M τ} ( ( m - {m}^{′} ) τ + k Δ {t}_{n , m} - {k}^{′} Δ {t}_{{n}^{′} , {m}^{′}} )}{Δ {t}_{{n}^{′} , {m}^{′}}} . \qquad ( 9 )$$

The inequality in expression (8), which can be reduced to the original expression (3), is obtained by setting t=kΔt_{n,m} and t′=(k′+α)Δt_{n′,m′}.

The path planning unit 20 first derives an initial solution of the paths with the problem being relaxed by ignoring the constraints on the diameter r of the agents 50 and the objective of the period τ. Then, the path planning unit 20 optimizes the solution by solving a continuous optimization problem in order to satisfy all of the original constraints and improve the quality of the solution in relation to the period τ. This approach aims to derive the paths of solutions in successive settings of space and time and simultaneously suppress values in successive cycles that affect the solutions to minimize those values. The calculation unit 22 that calculates the initial solution and the planning unit 24 that calculates the optimal solution are both described in detail below.

The calculation unit 22 calculates an initial solution of the respective paths of the plural agents 50 for a case in which the plural agents 50 respectively appear with a periodic appearance cycle at respective appearance points in the area 60. As this initial solution of the paths, the calculation unit 22 calculates the paths with an appearance cycle that is calculated such that the initial solution of the paths can be obtained. The calculation unit 22 sets sizes of the agents 50 to be smaller than their actual sizes when calculating the initial solution. As a result, the initial solution is easier to obtain.

More specifically, the calculation unit 22 calculates an initial value of the radius r that is significantly smaller than in the original constraint. The calculation unit 22 calculates an initial value of the period τ by determining how large a value of the period τ allows an initial solution of the paths to be obtained. That is, the calculation unit 22 calculates an initial value of the period τ that is comfortably large enough that the initial solution can be obtained. The initial value of the radius r is not limited during the calculations; a fixed value may be used. The calculation unit 22 then uses a previously known algorithm to calculate an initial solution of a set of paths Γ_{M}.

The planning unit 24 optimizes the initial solution so as to satisfy the constraints, including collision avoidance between the agents 50, and minimize the appearance cycle, and the planning unit 24 plans respective paths for the plural agents 50. More specifically, the planning unit 24 formularizes and optimizes an objective function as a continuous optimization problem. The objective function includes the period τ, the paths γ_{n,m} and a cost coefficient representing a penalty relating to the above-mentioned constraints. Thus, the planning unit 24 calculates an optimal solution of the set of paths Γ_{M}. The objective function includes the size of the agents 50 as a variable parameter and includes a cost function representing a penalty that is a difference between the value of the variable parameter and the actual size.

More specifically, when the planning unit 24 assigns the initial solution of the set of paths Γ_{M}, the agent radius r, period τ and paths γ_{n,m} in the objective function of expression (10) below are optimized so as to comprehensively satisfy the original constraints (expression (4), expression (5) and expression (8)). The term c (τ,r,Γ_{M}) in expression (10) is the cost function, which is shown in expression (11) below.

$$V ( τ , r , {Γ}_{M} ) := {( τ - \frac{2 r}{{v}_{max}} )}^{2} + \frac{{σ}_{t}}{K} {\sum }_{n , m , k} {v}_{n , m , k}^{2} + c ( τ , r , {Γ}_{M} ) , \qquad ( 10 )$$

$$c ( τ , r , {Γ}_{M} ) := {{σ}_{r} ( r - {r}_{0} )}^{2} + \frac{{σ}_{v}}{K} {\sum }_{n , m , k} {( max \{ 0 , {v}_{n , m , k} - {v}_{max} \} )}^{2} + \frac{{σ}_{o}}{K} {\sum }_{n , m , k} {( max \{ 0 , {{dist}_{ε} ( {x}_{n , m , k} )}^{- 1} - {r}^{- 1} \} )}^{2} + \frac{{σ}_{c}}{K} {\sum }_{C} {( max \{ 0 , {d}_{n , m , k , {n}^{′} , {m}^{′} , {k}^{′}}^{- 1} - {( 2 r )}^{- 1} \} )}^{2} , \qquad ( 11 )$$

The first term at the right side of expression (11) assigns a penalty for violation of the constraint of the actual size r₀ of the agents 50. The second term assigns a penalty for violation of the constraint on maximum speed of the agents 50, the third term assigns a penalty for violation of the constraint of clearances from boundaries, and the fourth term assigns a penalty for violation of the collision avoidance constraint. Thus, penalties for violations of the constraints may be specified as a cost function, and the cost function may be formularized as a continuous optimization problem without constraints. The terms σₜ, σᵣ, σᵥ, σₒ and σ_{c} are constants. The second term of the objective function is a cost of paths defined by a sum of squares of speed, to prevent gradients of the paths vanishing.

The planning unit 24 aims to decrease the period τ to a minimum of 2r/vₘₐₓ, for when two of the agents 50 pass close by one another. For example, the planning unit 24 solves the optimization problem described above by a previously known continuous optimization algorithm such as the Levenberg-Marquardt algorithm or the like. To force the solution to strictly satisfy the original constraints, the planning unit 24 steadily increases the constants σᵣ, σᵥ, σₒ and σ_{c} during the optimization so as to be significantly larger. Because the cost term for paths that is defined by a sum of squares of speed is required only to prevent vanishing of gradients and is not included in the original constraints, the planning unit 24 gradually reduces the constant σₜ to zero. The planning unit 24 passes the optimal solution of the period τ and set of paths Γ_{M} obtained by the optimization to the communication unit 30.

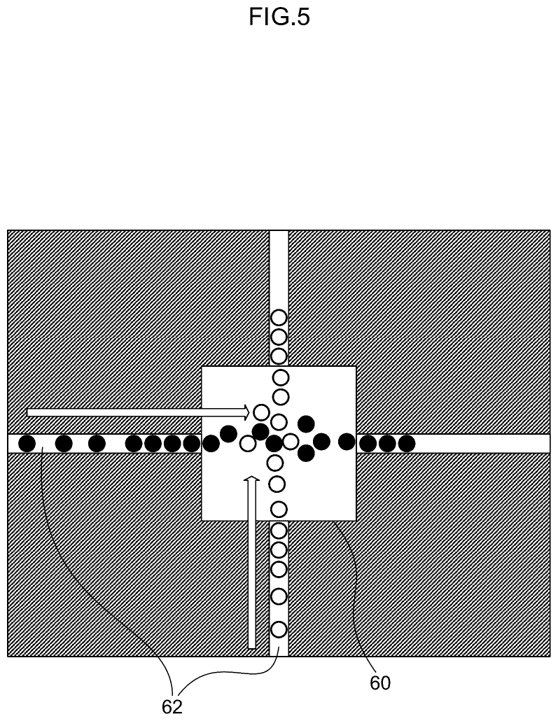

In the present exemplary embodiment, as shown in FIG. 5, pathways 62 that pass through respective appearance points are provided outside the area 60. FIG. 5 shows an example of the pathways 62 at the area 60 in which the pairs of appearance points and destination points shown in FIG. 3 are specified. In FIG. 5, the agents 50 that enter the area 60 through the appearance point s₁ are depicted as black circles and the agents 50 that enter the area 60 through the appearance point s₂ are depicted as white circles. The agents 50 appear outside the area 60 at arbitrary timings and proceed towards the area 60 along the pathways 62 that pass through the appearance points, which are entrances when the agents 50 enter into the area 60. FIG. 5 also includes pathways along which the agents 50 exiting the area 60 through the departure points proceed.

The communication unit 30 notifies each agent 50 appearing in the pathways 62 with the period τ and a path γ_{n,m}. The path γ_{n,m} notified to the agent 50 is a path for cycle m, when the agent 50 starts from the appearance point sₙ corresponding to the pathway 62 in which the agent 50 appeared. The communication unit 30 may notify the agent 50 with signals representing permission to enter the area 60 at the timing of cycle m of the period τ, together with the path γ_{n,m}, when the agent 50 is nearly at the appearance point sₙ.

Thus, the communication unit 30 controls the agent 50 so as to enter the area 60 at a timing of the minimized period τ. That is, the communication unit 30 performs control such that an agent 50 reaching near to the appearance point before the timing of the period τ waits in the pathway 62 until the timing of the period τ. The agent 50 entering the area 60 at the timing of the period τ moves through the area 60 along the notified path γ_{n,m}, reaches the destination point, and exits from the area 60.

Now, operation of the multi-agent control system 100 according to the present exemplary embodiment is described.

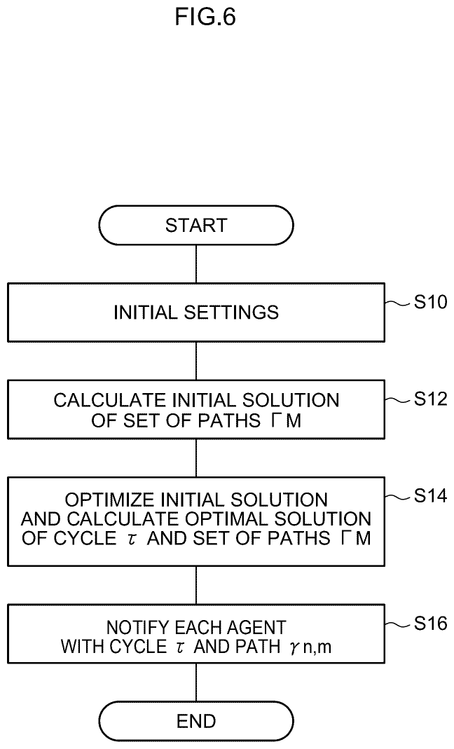

FIG. 6 is a flowchart showing a flow of path planning processing that is executed by the CPU 32 of the control device 10. The CPU 32 reads the path planning program from the memory device 36, loads the program into the memory 34 and executes the program. Consequently, the CPU 32 functions as the functional structures of the control device 10 and executes the path planning processing shown in FIG. 6.

In step S10, the calculation unit 22 performs initial settings for solving the periodic MAPP problem. Specifically, the calculation unit 22 specifies appearance points and destination points in the area 60, the environment E, the cycle number M, the radius r₀ corresponding to the actual sizes of the agents 50, an initial value of the radius r, and the maximum speed vₘₐₓ of the agents 50. As the initial value of the radius r, the calculation unit 22 specifies a value that is significantly smaller than r₀.

In step S12, the calculation unit 22 calculates an initial value of the period τ that is a sufficiently large value to enable calculation of an initial solution of the paths, and calculates the initial solution of the set of paths Γ_{M} such that the constraint of maximum speed of the agents 50 given in expression (4), the constraint of clearances from boundaries given in expression (5) and the constraint of collision avoidance given in expression (8) are satisfied. The initial value of the radius r may also be calculated in this step.

In step S14, on the basis of the initial solution of the set of paths Γ_{M} calculated in step S12, the planning unit 24 optimizes the solution such that the agent radius r, period τ, and set of paths γ_{n,m} in the objective function of expression (10) thoroughly satisfy the original constraints. Thus, the planning unit 24 calculates an optimal solution of the period τ and set of paths Γ_{M}.

In step S16, the communication unit 30 notifies each agent 50 with the period τ and the corresponding path γ_{n,m}, and the path planning process ends.

The agent 50 enters the area 60 at the timing of cycle m of the notified period τ, moves through the area 60 along the notified path γ_{n,m}, reaches the destination point, and exits from the area 60.

As described above, in the multi-agent control system according to the present exemplary embodiment, when plural pairs of appearance points that are entry points of agents into an area and destination points that are exit points of the agents from the area are defined, and plural agents respectively appear with a periodic appearance cycle at respective appearance points in the area, the path planning unit of the control device calculates an initial solution of respective paths of the plural agents from the appearance points to the destination points, which is paths for an appearance cycle that is calculated so as to allow the initial solution to be obtained. Then the path planning unit optimizes the initial solution so as to satisfy constraints, including collision avoidance between the agents, and minimize the appearance cycle, and the path planning unit plans respective paths for the plural agents. As a result, path planning with high throughput is enabled for multi-agent path planning that assigns new movement tasks for agents during execution of a path plan.

In the multi-agent control system according to the present exemplary embodiment, the communication unit of the control device allocates optimized paths in accordance with appearance timings at which the agents periodically appear in the area with the optimized appearance cycle. Therefore, the paths planned by the path planning unit may be applied to Online MAPP. As a result, high throughput may be achieved with very little path planning in real time or communication between the agents.

In the present exemplary embodiment, the periodic MAPP is a continuous optimization solution that is relaxed, formularized and solved using a previously known continuous optimization algorithm. Therefore, a good-quality solution may be found in a practical calculation duration.

The technique of the present disclosure may be applied to, for example, automatic intersection management. When a number of agents crossing an intersection is great enough to cause congestion, intersection throughput may be made higher than with a conventional technology by employing the technique of the present disclosure, and large numbers of agents may pass through the intersection without causing congestion. Even when the agents are arriving at the intersection at arbitrary timings, the control device adjusts times of entry into the intersection to be periodic and, when entering the intersection, the agents run along the decided paths. Therefore, control of the agents within the intersection is unnecessary and communication amounts may be reduced. When all the agents are self-driving vehicles, a technology that makes intercommunication signals unnecessary is enabled by employing the technique of the present disclosure.

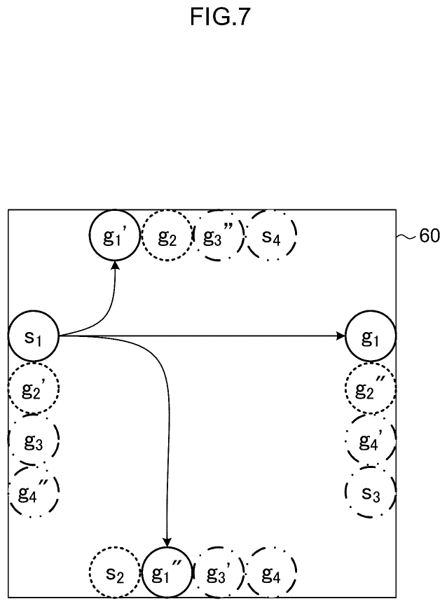

FIG. 7 is a diagram showing an example of the area 60 corresponding to an intersection for self-driving vehicles. When an agent is to appear from appearance point s₁ and proceed straight through the intersection area, the path planning device plans a path with g₁ as the destination point, when the agent is to turn left, the path planning device plans a path with g₁′ as the destination point, and when the agent is to turn right, the path planning device plans a path with g₁″ as the destination point. Paths of agents within the intersection may be similarly planned by deciding respective destination points for when the agents are proceeding straight, turning left and turning right from the respective appearance points of the intersection. In the example in FIG. 7, gₙ depicts a destination point for proceeding straight from an appearance point sₙ (n=equals 1, 2, 3 or 4), a destination point gₙ′ is depicted for turning left, and a destination point gₙ″ is depicted for turning right. Although not shown in the drawing, appearance points that correspond to proceeding straight, turning left and turning right may be provided. This corresponds to a situation of an actual intersection in which entry paths into the intersection are restricted to proceeding straight, turning left or turning right.

The technique of the present disclosure may be applied to control of agents in a warehouse, a factory or the like in which plural agents that are AMRs, AGVs or the like are running around. Because the technique of the present disclosure is a technology for agents to cross limited areas efficiently, smaller intersection areas may be enabled and maximum amounts of space for storage may be assured. Because the technique of the present disclosure makes communications between an intersection manager, agents and the like almost unnecessary, the technique of the present disclosure is applicable to robots that only have limited functions. When numerous robots are transporting goods in a warehouse, a factory or the like, the technique of the present disclosure may be employed effectively when types of start locations and target locations are limited.

In the exemplary embodiment described above, descriptions are given assuming that the agents are moving in a two-dimensional environment, but this is not limiting. The technology of the present disclosure may be applied to an intersection area in a three-dimensional environment, such as a flight space for unmanned aerial vehicles.

The path planning processing that, in the exemplary embodiment described above, is executed by a CPU reading software (a program) may be executed by various kinds of processor other than a CPU. Examples of processors in these cases include a PLD (programmable logic device) in which a circuit configuration can be modified after manufacturing, such as an FPGA (field-programmable gate array) or the like, a dedicated electronic circuit which is a processor with a circuit configuration that is specially designed to execute specific processing, such as an ASIC (application-specific integrated circuit) or the like, and so forth. The path planning processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

In the exemplary embodiment described above, a mode is described in which the path planning program is memorized in advance (installed) at a memory device, but this is not limiting. The program may be provided in a form memorized on a recording medium such as a CD-ROM, DVD-ROM, Blu-ray disc, Flash memory or the like. Modes are also possible in which the program is downloaded from external equipment via a network.

Supplementary notes on the present disclosure are recited below.

### —Supplementary Note 1—

A path planning device includes:
a calculation unit that, when plural agents respectively appear with a periodic appearance cycle at respective appearance points in an area in which plural pairs of the appearance points and destination points are defined, calculates an initial solution of respective paths of the plural agents from the appearance points to the destination points, the appearance points being entry points of the agents into the area, and the destination points being exit points of the agents from the area; and
a planning unit that optimizes the initial solution and plans the respective paths of the plural agents, the planning unit optimizing so as to satisfy constraints and minimize the appearance cycle, and the constraints including collision avoidance between the agents.

### —Supplementary Note 2—

In the path planning device according to supplementary note 1, the calculation unit calculates the appearance cycle such that the initial solution can be obtained, and the calculation unit calculates the paths with the calculated appearance cycle as the initial solution of the paths.

### —Supplementary Note 3—

In the path planning device according to supplementary note 1 or supplementary note 2, the planning unit plans the respective paths of the plural agents by optimizing an objective function that includes the appearance cycle, the respective paths of the plural agents from the appearance points to the destination points, and a cost function representing a penalty according to the constraints.

### —Supplementary Note 4—

In the path planning device according to supplementary note 3:
the calculation unit specifies a size of the agents that is smaller than an actual size for calculating the paths of the initial solution; and
the planning unit plans the respective paths of the plural agents by optimizing the objective function, the objective function including the size of the agents as a variable parameter, and the objective function including the cost function representing the penalty, the penalty being a difference between the value of the variable parameter and the actual size.

### —Supplementary Note 5—

In the path planning device according to supplementary note 3 or supplementary note 4, the planning unit: represents the path of each of the plural agents from the appearance point to the destination point as a finite number of variables approximating a polygonal chain; formularizes the objective function as a continuous optimization problem; and plans the respective paths of the plural agents.

### —Supplementary Note 6—

In the path planning device according to any one of supplementary notes 1 to 5, the planning unit specifies plural paths for a route from the appearance point to the destination point of one pair of appearance point and destination point, and plans the respective paths of the plural agents such that the agents that appear at that appearance point in respective appearance cycles follow the plural paths in rotation.

### —Supplementary Note 7—

The path planning device according to any one of supplementary notes 1 to 6 further includes a communication unit that performs control corresponding to each of the appearance points such that the agents appearing at arbitrary timings enter the area at timings of the minimized appearance cycle, and each agent appearing prior to a timing of the appearance cycle waits in a pathway that is specified outside the area until the timing of the appearance cycle, the pathway passing through the appearance point.

### EXPLANATION OF THE REFERENCE SYMBOLS

100 multi-agent control system
10 Control device
20 Path planning unit
22 Calculation unit
24 Planning unit
30 Communication unit
32 CPU
34 Memory
36 Memory device
38 Entry device
40 Output device
42 Memory medium reading device
44 Communications interface
46 Bus
50 Agent
60 Area
62 Pathway

1. A path planning device comprising:
a calculation unit that, when a plurality of agents respectively appear with a periodic appearance cycle at respective appearance points in an area in which a plurality of pairs of the appearance points and destination points are defined, calculates an initial solution of respective paths of the plurality of agents from the appearance points to the destination points, the appearance points being entry points of the agents into the area, and the destination points being exit points of the agents from the area; and
a planning unit that optimizes the initial solution and plans the respective paths of the plurality of agents, the planning unit optimizing so as to satisfy constraints and minimize the appearance cycle, and the constraints including collision avoidance between the agents.

2. The path planning device according to claim 1, wherein the calculation unit calculates the appearance cycle such that the initial solution can be obtained, and the calculation unit calculates the paths with the calculated appearance cycle.

3. The path planning device according to claim 1 or claim 2, wherein the planning unit plans the respective paths of the plurality of agents by optimizing an objective function that includes
the appearance cycle,
the respective paths of the plurality of agents from the appearance points to the destination points, and
a cost function representing a penalty according to the constraints.

4. The path planning device according to claim 3, wherein:
the calculation unit specifies a size of the agents that is smaller than an actual size for calculating the paths of the initial solution; and
the planning unit plans the respective paths of the plurality of agents by optimizing the objective function, the objective function including the size of the agents as a variable parameter, and the objective function including the cost function representing the penalty, the penalty being a difference between the value of the variable parameter and the actual size.

5. The path planning device according to claim 3, wherein the planning unit:
represents the path of each of the plurality of agents from the appearance point to the destination point as a finite number of variables approximating a polygonal chain;
formularizes the objective function as a continuous optimization problem; and
plans the respective paths of the plurality of agents.

6. The path planning device according to claim 1 or claim 2, wherein the planning unit specifies a plurality of paths for a route from the appearance point to the destination point of one pair of appearance point and destination point, and plans the respective paths of the plurality of agents such that the agents that appear at that appearance point in respective appearance cycles follow the plurality of paths in rotation.

7. The path planning device according to claim 1 or claim 2, further comprising a communication unit that performs control corresponding to each of the appearance points such that
the agents appearing at arbitrary timings enter the area at timings of the minimized appearance cycle, and
each agent appearing prior to a timing of the appearance cycle waits in a pathway that is specified outside the area until the timing of the appearance cycle, the pathway passing through the appearance point.

8. A path planning method comprising:
when a plurality of agents respectively appear with a periodic appearance cycle at respective appearance points in an area in which a plurality of pairs of the appearance points and destination points are defined, calculating an initial solution of respective paths of the plurality of agents from the appearance points to the destination points, the appearance points being entry points of the agents into the area, and the destination points being exit points of the agents from the area; and
optimizing the initial solution and planning the respective paths of the plurality of agents, including optimizing so as to satisfy constraints and minimize the appearance cycle, the constraints including collision avoidance between the agents.

9. A path planning program, wherein the path planning program causes a computer to function as:
a calculation unit that, when a plurality of agents respectively appear with a periodic appearance cycle at respective appearance points in an area in which a plurality of pairs of the appearance points and destination points are defined, calculates an initial solution of respective paths of the plurality of agents from the appearance points to the destination points, the appearance points being entry points of the agents into the area, and the destination points being exit points of the agents from the area; and
a planning unit that optimizes the initial solution and plans the respective paths of the plurality of agents, the planning unit optimizing so as to satisfy constraints and minimize the appearance cycle, and the constraints including collision avoidance between the agents.

10. A multi-agent control system comprising a control device and a plurality of agents, wherein
the control device includes:
a calculation unit that, when the plurality of agents respectively appear with a periodic appearance cycle at respective appearance points in an area in which a plurality of pairs of the appearance points and destination points are defined, calculates an initial solution of respective paths of the plurality of agents from the appearance points to the destination points, the appearance points being entry points of the agents into the area, and the destination points being exit points of the agents from the area;
a planning unit that optimizes the initial solution and plans the respective paths of the plurality of agents, the planning unit optimizing so as to satisfy constraints and minimize the appearance cycle, and the constraints including collision avoidance between the agents; and
a communication unit that notifies each of the plurality of agents with the optimized appearance cycle and the path,
wherein each of the plurality of agents:
enters the area at the timing of the notified appearance cycle;
when the each agent appears prior to the timing of the appearance cycle, waits in a pathway that is specified outside the area until the timing of the appearance cycle, the pathway passing through the appearance point;
after entering the area, moves from the appearance point to the destination point along the notified path; and
when reaching the destination point, exits from the area.
